(19) United States
(12) Patent Application Publication
(10) Pub. No.: US 2008/0082813 A1
(43) Pub. Date: Apr. 3, 2008

(54) PORTABLE USB DEVICE THAT BOOTS A COMPUTER AS A SERVER WITH SECURITY MEASURE

(76) Inventors: David Q. Chow, San Jose, CA (US); Edward W. Lee, Mountain View, CA (US); Abraham C. Ma, Fremont, CA (US); Ming-Shiang Shen, Taipei City (TW)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/861,133

(22) Filed: Sep. 25, 2007

Related U.S. Application Data
(63) Continuation-in-part of application No. 11/846,746, filed on Aug. 29, 2007.
Application No. 11/846,746 is a continuation-in-part of application No. 11/838,192, filed on Aug. 13, 2007.
Application No. 11/838,192 is a continuation-in-part of application No. 11/624,667, filed on Jan. 18, 2007.
Application No. 11/846,746 is a continuation-in-part of application No. 11/040,326, filed on Jan. 20, 2005.
Application No. 11/846,746 is a continuation-in-part of application No. 09/478,720, filed on Jan. 6, 2000, now Pat. No. 7,257,714.
Application No. 11/846,746 is a continuation-in-part of application No. 10/762,934, filed on Jan. 21, 2004.
Application No. 10/762,934 is a continuation-in-part of application No. 10/002,652, filed on Oct. 19, 2001, now Pat. No. 7,103,765.
(63) Continuation-in-part of application No. 11/685,143, filed on Mar. 12, 2007.
Application No. 11/685,143 is a continuation-in-part of application No. 09/478,720, filed on Jan. 6, 2000, now Pat. No. 7,257,714.
Application No. 11/685,143 is a continuation-in-part of application No. 11/377,235, filed on Mar. 15, 2006.

(51) Int. Cl. G06F 15/177; H04L 9/00; H04L 9/30

(52) U.S. Cl. 713/2; 380/44; 713/171

(57) ABSTRACT

Techniques for booting a host computer from a portable storage device with customized settings with secure measure are described herein. According to one embodiment, in response to detecting a portable storage device inserted into a first host computer, the portable storage device is authenticated using a private key stored within the portable storage device against a public key stored in a second host computer over a network. In response to a successful authentication, data representing a personal working environment associated with a user of the portable storage device is downloaded from the second host computer over the network. After reboot, the first host computer is configured using the obtained settings of the personal working environment, such that the user of the portable storage device can operate the second host computer in view of the personal working environment. Other methods and apparatuses are also described.

### RELATED APPLICATIONS

This application is a CIP (continuation-in-part) of co-pending U.S. patent application Ser. No. 11/846,746, filed Aug. 28, 2007, entitled “Portable USB Device That Boots a Computer as a Server”, which is a CIP of U.S. patent application Ser. No. 11/838,192, entitled “Multi-Partition USB Device that Re-Boots a PC to an Alternative Operating System for Virus Recovery”, filed Aug. 13, 2007, which is a CIP of co-pending U.S. patent application Ser. No. 11/624,667, filed Jan. 18, 2007, U.S. patent application Ser. No. 11/040,326, filed Jan. 20, 2005, and U.S. patent application Ser. No. 09/478,720, entitled “Electronic Data Storage Medium with Fingerprint Verification Capability”, filed Jan. 6, 2000, now U.S. Pat. No. 7,257,714. The U.S. patent application Ser. No. 11/846,746 is also a CIP of U.S. patent application Ser. No. 10/762,934, entitled “Method and System for Providing a Modular Server on USB Flash Storage”, filed Jan. 21, 2004, which is a CIP of U.S. patent application Ser. No. 10/002,652, filed Oct. 19, 2001, now U.S. Pat. No. 7,103,765.

This application is also a CIP of co-pending U.S. patent application Ser. No. 11/685,143, filed Mar. 12, 2007, entitled “Data Security for Electronic Data Flash Card”, which is a CIP of U.S. patent application Ser. No. 09/478,720, filed Jan. 6, 2000, entitled “Electronic Data Storage Medium With Fingerprint Verification Capability”, and a CIP of U.S. application Ser. No. 11/377,235, filed Mar. 15, 2006, entitled “System and Method for Providing Security to a Portable Storage Device”. The U.S. patent application Ser. No. 11/685,143 is also related to “Integrated circuit card with fingerprint verification capability” application Ser. No. 09/366,976, filed on Aug. 4, 1999, now U.S. Pat. No. 6,547,130.

The disclosure of the above-identified applications and patents is incorporated by reference herein in its entirety.

### FIELD OF THE INVENTION

The present invention relates generally to computer systems. More particularly, this invention relates to rebooting a computer from an operating system stored in a portable device.

### BACKGROUND

Personal computer systems have become common tools in modern society. Portable computer systems such as laptop or notebook computers are gaining more popularity because of their portable convenience. A user may carry a portable computer to a remote location without losing the customized operating environment that the user is familiar with. Thus, most users would prefer to utilize their own computer at any given time without having to sacrifice their individual operating environment or personal settings such as, for example, operating system, email client, word processor, etc.

However, under certain circumstances, it may be considered inconvenient to carry an item such as a notebook computer during a trip because it may still be considered to be “heavy.” Another inconvenience to the user would be fear of loss, theft or having their personal computer hacked, by a hacker. A remote place, such as a hotel in a foreign country, may provide a remote computer for a hotel guest to use; however, the operating environment of the remote computer may be different than the one on the home computer of the user, such as, for example, different operating systems, different native languages, or different applications, etc. Therefore, if the user wants to use a remote or foreign computer, the user is limited to whatever features or settings are available at the remote or foreign computer. In addition, certain secure content may not be accessible from the foreign computer, unless the user remembers user's authentication credentials. Furthermore, by using a foreign computer, a user may have concern about leaving personal or confidential information behind at the foreign computer.

### SUMMARY OF THE DESCRIPTION

Techniques for booting a host computer from a portable storage device with customized settings with secure measure are described herein. According to one embodiment, in response to detecting a portable storage device inserted into a first host computer, the portable storage device is authenticated using a private key stored within the portable storage device against a public key stored in a second host computer over a network. In response to a successful authentication, data representing a personal working environment associated with a user of the portable storage device is downloaded from the second host computer over the network. After reboot, the first host computer is configured using the obtained settings of the personal working environment, such that the user of the portable storage device can operate the second host computer in view of the personal working environment.

Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings in which like references indicate similar elements.

FIGS. 1A-1B are block diagrams illustrating a process of establishing an operating environment of a computer system according to one embodiment of the invention.

FIG. 2 is a block diagram illustrating an example of a portable storage device according to one embodiment of the invention.

FIG. 3 is a block diagram illustrating an example of a portable storage device having multiple partitions in accordance with one embodiment of the invention.

FIG. 4 is a block diagram illustrating an example of personal working environment image according to one embodiment of the invention.

FIG. 5 is a block diagram illustrating an example of a user partition according to one embodiment of the invention.

FIG. 6 is a flow diagram illustrating a process for establishing an operating environment of a host computer according to one embodiment of the invention.

FIG. 7 is a block diagram illustrating an example of a workgroup configuration according to one embodiment of the invention.

FIG. 8 is a block diagram illustrating an example of system configuration which may be applied to CPRM/CPPM applications according to one embodiment of the invention.

FIG. 9 is a flow diagram illustrating a process for establishing an operating environment of a host computer according to another embodiment of the invention.

FIGS. 10A-10B show account and media player setup, media content downloading and playing for a secure digital rights management (DRM) system, according to one embodiment of the invention.

FIG. 11 is a block diagram illustrating a host computer according to one embodiment of the invention.

FIG. 12 is a block diagram illustrating a portable storage device according to one embodiment of the invention.

### DETAILED DESCRIPTION

Techniques for booting a host computer from a portable storage device with customized settings with secure measure are described herein. In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment.

According to certain embodiments, a portable storage device such as a USB (universal serial bus) device may be used to store any personal configuration and/or operating environment associated with a user's own computer. Such a storage device may be carried by the user to travel to a remote location and used with a foreign computer that may have a different operating environment or settings. The customized configuration of an operating environment associated with the user may be used to configure the foreign computer into a customized operating environment that is similar to the one available at the user's own computer.

The original configurations of the foreign computer are not utilized. Instead, the foreign computer is booted from an operating system (OS) image stored in the portable device and utilizes a personal configuration file that has captured the personal settings of the user to configure the operating environment at the foreign computer. As a result, a user would operate any foreign computer and utilize their own personalized operating environment such as if the user were operating their computer at home.

According to one embodiment, the portable storage device includes certain authentication credentials such as username, password, and a private key. When the portable storage device is inserted into a foreign host computer, before rebooting the foreign host, the portable storage device is authenticated using the authentication credentials with respect to a remote host computer or server. The foreign host computer is rebooted from an OS image stored in the portable storage device only if the portable storage device has been successfully authenticated. Further, the portable storage device includes certain CPRM (content protection recordable media) or CPPM (content protection pre-recorded media) authentication mechanism to authenticate or verify certain CPRM/CPPM content stored locally or downloaded from a remote facility. Thus, a user may use a portable storage device as a security pass or authentication tool to gain accesses to a remote facility over a network.

Note that throughout this application, a portable storage device having a USB interface is utilized as an example of a portable storage device. However, it is not so limited; other portable storage devices having other interfaces, such as, for example, IEEE-1394 (also referred to as Firewire), PCMCIA (personal computer memory card international association), SATA, SD/MMC or other storage devices may also be applied.

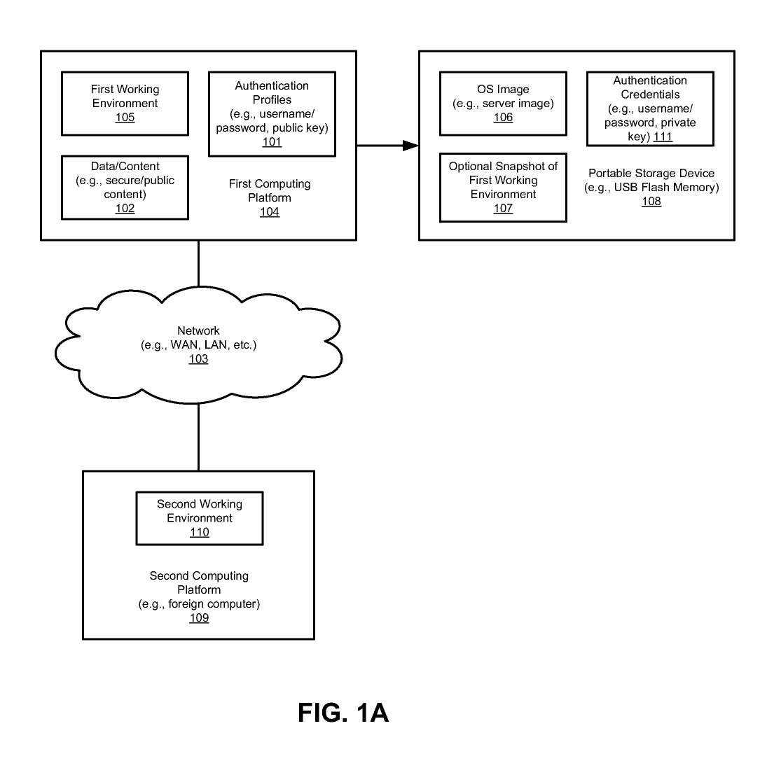

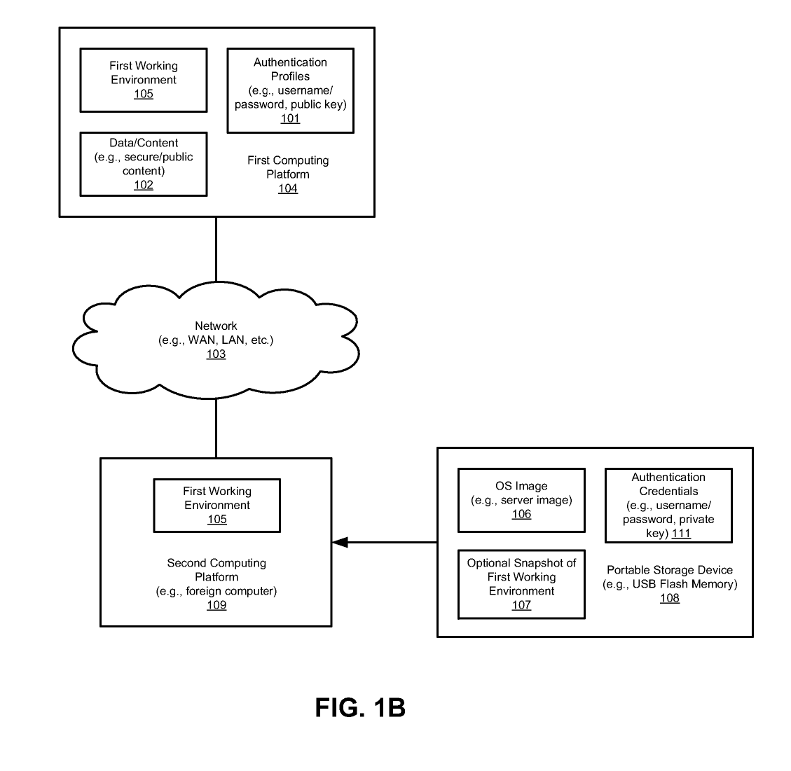

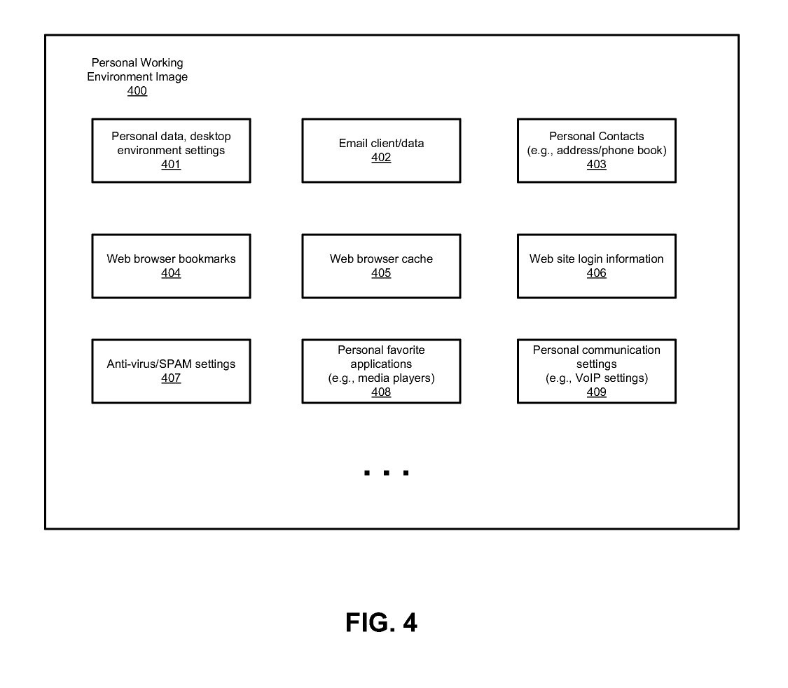

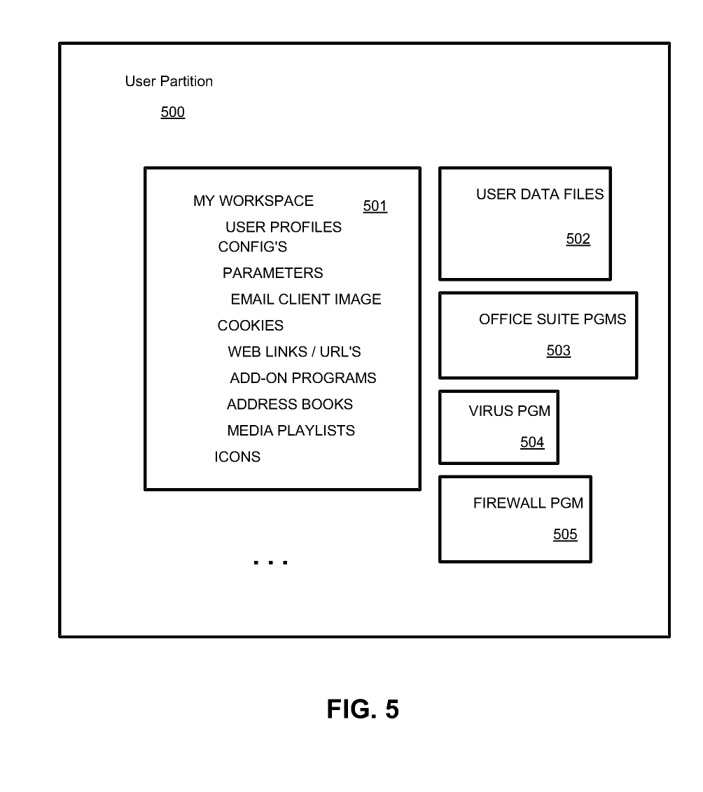

FIGS. 1A-1B are block diagrams illustrating a process of establishing an operating environment of a computer system according to one embodiment of the invention. Referring to FIG. 1A, initially, a USB storage device 108 is inserted into a local computer 104 which is operating in a first working environment 105. The first working environment 105 may be customized by a user of the portable storage device 108 having certain user's favorite or preferred settings or applications. For example, the first working environment 105 may include the user's customized desktop settings, email client, media player, word processor, or antivirus/SPAM settings, etc. as shown in FIGS. 4-5.

When the USB storage device 108 is inserted into the first computer 104, the first working environment 105 may be captured and stored in the USB storage device 108 as a personal configuration file 107. In addition, certain authentication credentials 101 of the user may also be replicated in the portable storage device 108 as authentication credentials 111. The authentication credentials 111 may be used for remotely accessing host 104, such as, for example, data or content 102 subsequently. For example, authentication credentials 101 may include a username, a password, and/or a public key associated with the user. Likewise, authentication credentials 111 may include a username, a password, and/or a private key associated with the user.

According to one embodiment, upon detecting an insertion of the USB device into a host computer such as host computer 104, the host computer 104 responds with checking on a “Bootable” or “Launchable” partition on the USB device 108. That triggers the “launch” of a “Utility application software” within the host computer 109, and a “User Menu” comes up on the computer screen. It shows a multiple selection list for an end user to select or pick up all the application suite, OS configurations, work environment set-up specific parameters, client software, such as email, Web configurations, favor Multi-media app-lets. With one-bottom click or an activation, the host computer 109 starts collecting all related configurations, parameter settings, and “wrap around” to produce a “Work image” of the host computer work environment, which is stored in a “User specified partition” of the USB storage device. For another example, in a Windows operating environment available from Microsoft Corporation of Redmond, Wash., a utility application may “walk through” certain areas of the Windows registry to obtain installation and configuration information of certain applications that are running within the Windows operating system. This information may then be compressed into a relatively small size configuration file 107 stored in the USB storage device 108. The configuration file 107 may be encrypted using a variety of security measures since the configuration file 107 may include certain personal confidential information. In addition, the USB storage device 108 may further include an operating system image 106 (e.g., a server OS image) which may be used to reboot an external computer into a server without using an OS inside of the external computer. Alternatively, the above information may be collected by host 104 and stored within host subsequent download.

Subsequently, as shown in FIG. 1B, the user may carry the USB storage device 108 and insert into a remote or foreign computer 109, where computer 109 may operate in a second operating environment 110. The second operating environment 110 may operate under the same or different operating system as of computer 104. However, the personal configuration of the operating environment (also referred to herein as working environment) may be different from the one in computer 104. When the USB storage device 108 is inserted into the second computer 109 via a USB interface of the computer 109, the USB storage device 108 is detected and recognized, for example, via a plug-n-play feature of the operating system running therein. The USB storage device 108 is then mounted by the operating system (e.g., file system) as a mass storage.

Thereafter, a reboot process may be initiated by the user manually or automatically. In response to the reboot request, according to one embodiment, USB storage device 108 may be authenticated with the host 104 over network 103, which may be wide area network (WAN) such as the Internet, or a local area network (LAN) such as a Intranet of an entity or company. The USB device 108 may be authenticated using authentication credentials 111 against the authentication credentials 101 of host computer 104. Only upon a successful authentication, the host computer 109 is rebooted from OS image 106 of the USB device 108; otherwise, the host computer 109 is rebooted as regularly using its own operating system.

Furthermore, upon successfully authenticating the USB device 108 with respect to host computer 104, data representing the first working environment 105 may be downloaded from host computer 104 to USB device 108 (e.g., as part of snapshot of working environment 107). The downloaded data may be encrypted via a public key of host computer 104 and may be decrypted by the USB device 108 using a private key associated with the public key.

Public key cryptography, also known as asymmetric cryptography, is a form of cryptography in which a user has a pair of cryptographic keys—a public key and a private key. The private key is kept secret, while the public key may be widely distributed. The keys are related mathematically, but the private key cannot be practically derived from the public key. A message encrypted with the public key can be decrypted only with the corresponding private key. Conversely, secret key cryptography, also known as symmetric cryptography uses a single secret key for both encryption and decryption.

The two main branches of public key cryptography are: 1) public key encryption—a message encrypted with a recipient's public key cannot be decrypted by anyone except the recipient possessing the corresponding private key; 2) digital signatures—a message signed with a sender's private key can be verified by anyone who has access to the sender's public key, thereby proving that the sender signed it and that the message has not been tampered with. Other techniques such as digital certificates may also be utilized. Note that the above authentication and encryption/decryption operations can be implemented using a variety of algorithms and/or protocols such as PGP (pretty good privacy) or RSA authentication algorithm.

During the reboot, either a warm boot or a cold boot, the BIOS code is executed to perform certain initialization operations (e.g., POST or power-on self-test). After the BIOS detects the inserted USB storage device, the BIOS may further detect a boot sector located within the USB storage device. For example, the BIOS may launch a local control program (not shown) of the USB storage device which in turn locates and executes the boot sector of the USB device to boot up the computer 109 using the OS image 106. Thus, instead of booting up computer 109 using the original OS of computer 109, the BIOS may invoke the local control program of the USB storage device to take over the booting sequence control. As a result, computer 109 is booted using the OS image 106.

Once the computer 109 boots up using OS image 106 to establish an operating environment (e.g., desktop environment), the personal configuration file 107, which may be downloaded from host computer 104 upon a successful authentication as described above, is extracted to configure the operating environment to include certain personal settings of the user. As a result, the operating environment of computer 109 may have a working environment similar to the one of computer 104, which the user is familiar with. Additional data or content such as content 102 may also be downloaded from host computer 104. Such content may be secure content such as CPRM/CPPM compliant content and such content may be authenticated or authorized by for example, authentication credentials 111 of the USB device 108. Further, a user of USB device 108 may securely access a remote server such as CPRM/CPPM license server to download or verify additional CPRM/CPPM content to be used in the host computer 109. For example, a user of USB device 108 may purchase additional CPRM/CPPM media content (e.g., audio/video content) from a server using certain CPRM/CPPM credentials stored in the USB device and play the downloaded media content using a CPRM/CPPM compliant media player.

Once the user has finished using the remote computer 109 (e.g., leaving the hotel or a client site), the user may unplug the portable storage device 108 from the host computer 109 and be ready to go home or go to another remote site. In response to the portable storage device 108 removed from the host computer 109, according to one embodiment, certain “garbage collection” operations may be performed on the host computer 109. For example, certain temporary files (e.g., cached files or temporary files downloaded from a Web page) stored at a storage of the host computer 109 may be erased. As a result, any possible personal confidential information associated with the user may be removed from the remote computer 109.

Furthermore, according to one embodiment, if the user modifies any settings of the working environment (e.g., changes of the address/phone book or Web links/bookmarks, etc.) while operating the host computer 109, prior to removing the portable storage device 108 from the host computer 109, at least a portion of the modified working environment settings may be saved back (e.g., synchronized) to the portable storage device 108. Thus, when a user carrying the portable storage device 108 goes back to the user's own computer (e.g., local or home computer), the modified working environment can be restored from the portable storage device 108 back to the user's own computer (e.g., computer 104).

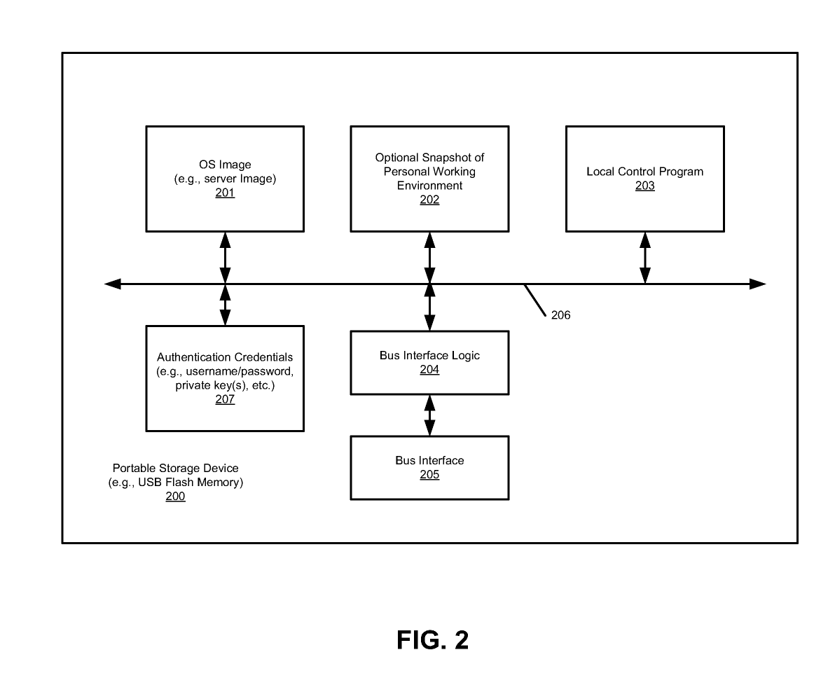

FIG. 2 is a block diagram illustrating an example of a portable storage device according to one embodiment of the invention. For example, portable storage device 200 may be implemented as part of portable storage device 108 of FIG. 1. Referring to FIG. 2, portable storage device 200 includes, but is not limited to, an OS image 201, a personal working environment image 202, local control program or programs coupled to each other via a bus or interconnect 206, and authentication credentials 207 (e.g., username, password, private key). The portable storage device 200 further includes a bus interface logic 204 and bus interface 205 which are used to interface the portable storage device 200 with an external device (e.g., external host computer) via proper bus protocols (e.g., USB protocols). OS image 201 may be implemented as part of OS image 106 of FIG. 1 and personal working environment image 202 may be implemented as part of working environment image 107 of FIG. 1.

As described above, when the portable storage device 200 is inserted into an external host computer, the OS image 201 may be used to boot, via local control program 203, an external host computer without using the original OS of the external host computer. Once the host computer boots up and authenticated, the personal working environment image 202 is extracted and used to configure the operating environment of the host computer to have a predetermined working environment associated with a user of the portable storage device 200. Note that the personal working environment image 202 may be downloaded from a remote facility upon successful authentication as described above.

In addition, the portable storage device 200 may optionally include other control logic. In one embodiment, the other control logic is managed by the local control program 203. Further, portable storage device 200 may includes a variety of connectors (not shown), including an initialization connector, a shut-down connector, a power control connector, a status LED connector, a DC power LED connector, and/or a LCD display connector, etc. However, in another embodiment, the other control logic could include other components. The connectors can be coupled to LEDs (not shown) and an LCD display (not shown) integrated with the portable storage device 200. Further detailed information regarding operations of these components can be found in the above incorporated by reference applications.

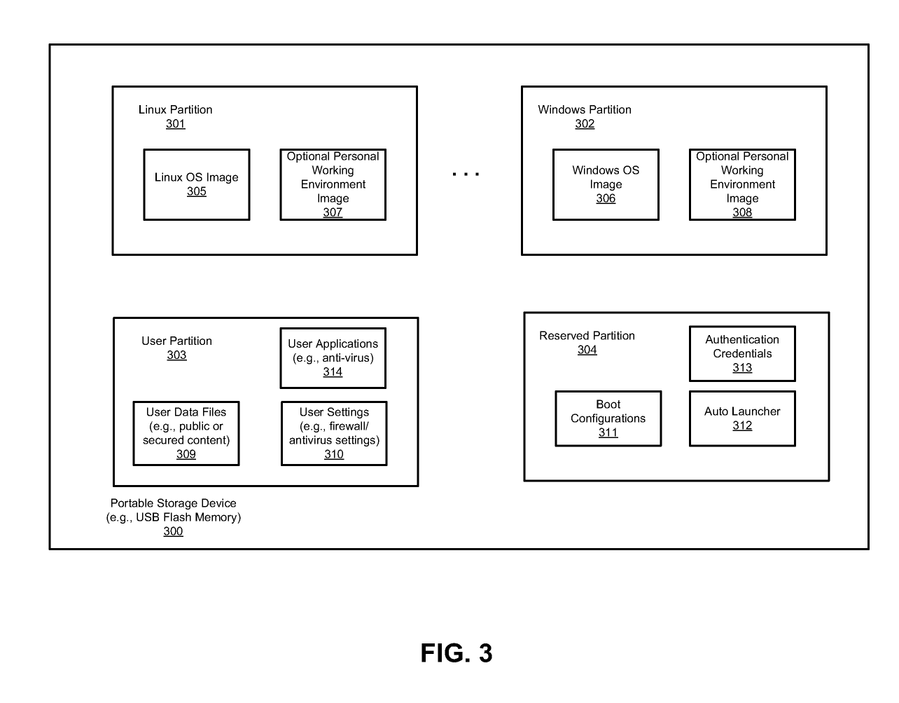

According to certain embodiments, the portable storage device may be implemented in a single partition or multiple partitions. FIG. 3 is a block diagram illustrating an example of a portable storage device having multiple partitions in accordance with one embodiment of the invention. For example, portable storage device 300 may be implemented as part of portable storage device 200 of FIG. 2. Referring to FIG. 3, in one embodiment, portable storage device 300 includes multiple partitions for storing multiple different OS images such as Linux partition 301 for Linux OS related files and Windows partition 302 for Windows OS related files. Each of the OS related partitions includes a OS image (e.g., images 305-306) used to boot a host computer into a corresponding OS environment and an optional personal working environment image (e.g., images 307-308) to customize or personalize the corresponding OS environment, which may be downloaded from a remote facility upon successful authentication. The portable storage device 300 may further include a user partition 303 having user data files 309, user configurations 310 (e.g., firewall/anti-virus settings), and user applications 314 such as anti-virus, firewall applications, or a media player (e.g., CPRM/CPPM compliant media player). Further, portable storage device 300 includes a reserved partition 304 having a boot configuration 311, auto launcher program 312, and authentication credentials 313 (e.g., username/password/private key).

Specifically, referring to FIG. 3, Linux partition 301 stores Linux OS image 305, which includes the OS routines, definitions, modules, and drivers that are loaded into a computer's main memory just before running Linux. Linux-based user programs and data can also be stored in Linux partition 301, such as Linux anti-virus program which can scan for and clean viruses and other malware.

Microsoft Windows partition 302 includes Microsoft Windows OS image 306, which includes the OS routines, definitions, modules, applications-programming-interface (API) interpreters, and drivers that are loaded into a computer's main memory just before running Microsoft Windows. Microsoft Windows based user programs and related data can also be stored in Microsoft Windows partition 40, such as Microsoft Windows applications.

User partition 303 stores use data files 309 which may be accessed by any operating system when each OS has a corresponding driver or program that can open files of that file-type. User configurations 310 can include configuration data that may be specific to one operating system or another, or may include generic configuration information.

Reserved partition 304 is a partition of flash memory in the USB device that stores a control program and related data that is executed by the USB device itself. The USB device then notifies the host computer of the presence of a bootable device desiring to auto-launch an application. The host computer may then transfer control to the bootable device for execution. Boot configurations 311 includes configuration data about the partitions stored in the flash memory of the USB device, such as the association of partitions 301-302 with certain buttons described above, and which partition's data to transfer to a host computer and what action or program to run when each of buttons is activated.

Auto-launcher 312 is a program that helps copy data from one of partitions 301-302 to a host computer being booted when the portable storage device 300 is inserted into the host computer and recognized by the OS that is running on the host computer. Auto-launcher 312 may be a Launch Pad application that check the data type and brings up a list or menu of application software that end users can click on to activate their favorite application software for further action. For example, if the data is MP3 type, then auto-launcher 312 brings up a list of Media player or decoder software for end users to click and choose. Other configurations may exist. Further, the auto-launcher 312 may further trigger downloading content from a remote facility and use authentication credentials 313 to authenticate and/or decrypt the downloaded content.

FIG. 4 is a block diagram illustrating an example of personal working environment image according to one embodiment of the invention. For example, personal working environment 400 may be implemented as part of working environment images 307-308 of FIG. 3, which may also be downloaded from a remote facility upon successful authentication. Referring to FIG. 4, in this example, personal working environment 400 includes information representing a variety of personal or customized settings, including personal data and desktop settings 401, email client and settings 402, and personal contacts 403 such as an address book and/or phone book. The personal working environment 400 may further include certain Web browser settings such as, for example, Web browser bookmarks 404, Web browser cache 405, and Web site login information 406, etc. The personal working environment 400 may further include other applications such as anti-virus/SPAM applications or settings 407, personal favorite applications 408 such as media players, and personal communication settings 409 such as VoIP or instant messaging settings, etc. Other personal items may also be included.

FIG. 5 is a block diagram illustrating an example of a user partition according to one embodiment of the invention. For example, user partition 500 may be implemented as part of user partition 303 of FIG. 3. Referring to FIG. 5, user partition 500 stores user data files 502 which may be accessible in one or both operating systems, depending on applications available in the operating systems. Office suite programs 503 may include Microsoft Windows office software such as word processing, spreadsheet, contact, and scheduling software, or office suite software for Linux or another operating system. Virus program 504 can detect and remove viruses while running on Linux. Firewall program 505 protects the user's computer from external attacks when connected to a network such as the Internet. User configurations 501 can include a wide variety of user configuration data for one or for both operating systems. User profiles or workspaces stored in user configurations 52 may include parameters, email client images, web cookies, links, and universal resource locators (URL's), web browser add-on programs, address books, media playlists and settings, icons, and other user-specific data. Other components may also be included.

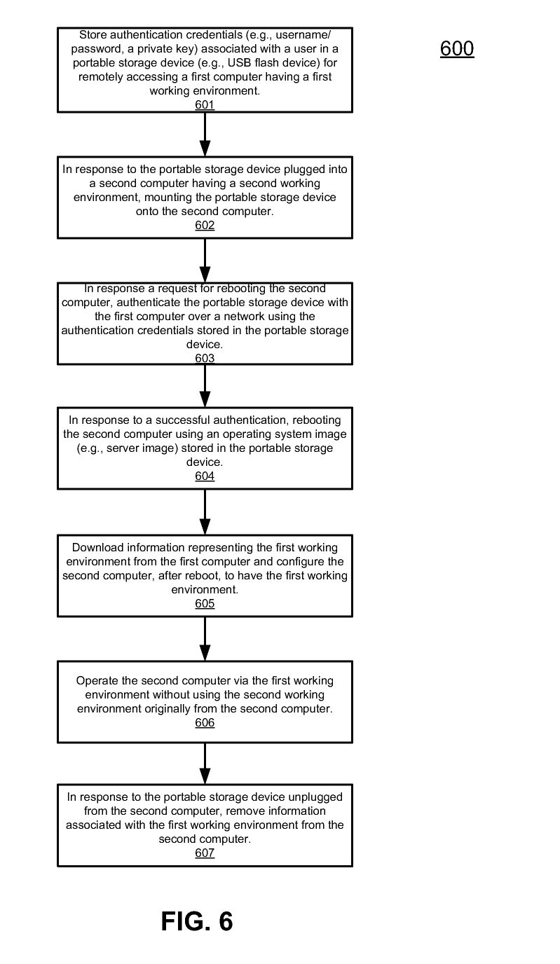

FIG. 6 is a flow diagram illustrating a process for establishing an operating environment of a host computer according to one embodiment of the invention. Note that process 600 may be performed by processing logic which may include software, hardware, or a combination of thereof. For example, process 600 may be performed by systems as shown in FIGS. 1A-1B and 2. Referring to FIG. 6, in response to a portable storage device (e.g., USB flash memory device) inserted into a first host computer, at block 601, processing logic stores authentication credentials (e.g., username/password and private key) associated with a user into a portable storage device (e.g., USB flash memory device) for remotely accessing a first host computer having a first working environment. At block 602, in response to an insertion of the portable storage device into a second host computer having a second working environment, mounting the portable storage device as a storage drive in the second host computer.

At block 603, in response to a request for rebooting the second host computer, processing logic authenticates the portable storage device with the first computer over a network using the authentication credentials stored in the portable storage device. In response to successful authentication, at block 604, rebooting the second host computer using an operating system image stored in the portable storage device. At block 605, processing logic downloads information representing the first working environment from the first host computer and configures the second host computer to have the first working environment, and operate the second host computer in a first working environment at block 606.

Once the user has finished using the second computer (e.g., leaving the hotel or a client site), the user may unplug the portable storage device from the second host computer and be ready to go home or go to another remote site. In response to the portable storage device removed from the second host computer, at block 607, processing logic may perform certain “garbage collection” operations on the second host computer. For example, certain temporary files (e.g., cached files or temporary files downloaded from a Web page) stored at a storage of the second host computer may be erased.

Furthermore, according to one embodiment, if the user modifies any settings of the working environment (e.g., changes of the address/phone book or Web links/bookmarks), prior to removing the portable storage device from the second host computer, at least a portion of the modified working environment settings may be saved back (e.g., synchronized) to the portable storage device. Thus, when a user carrying the portable storage device goes back to the user's own computer (e.g., local or home computer), the modified working environment can be restored back to the user's own computer. Other operations may also be performed.

Note that techniques described above in accordance with embodiments of the present invention can be applied to a variety of mass storage devices such as Serial ATA FLASH hard drive, IDE FLASH hard drive, SCSI FLASH hard drive and Ethernet FLASH hard drive. In addition, a FLASH controller in accordance with the present invention also applies to FLASH memory cards such as Express Card, Mini PCI Express Card, Secure Digital Card, Multi Media Card, Memory Stick Card and Compact FLASH card. Finally, a system in accordance with the present invention also applies to the other serial buses such as PCI Express bus, Serial ATA bus, IEEE 1394 bus and Ethernet bus. Accordingly, many modifications may be made by one of ordinary skill in the art without departing from the spirit and scope of the appended claims.

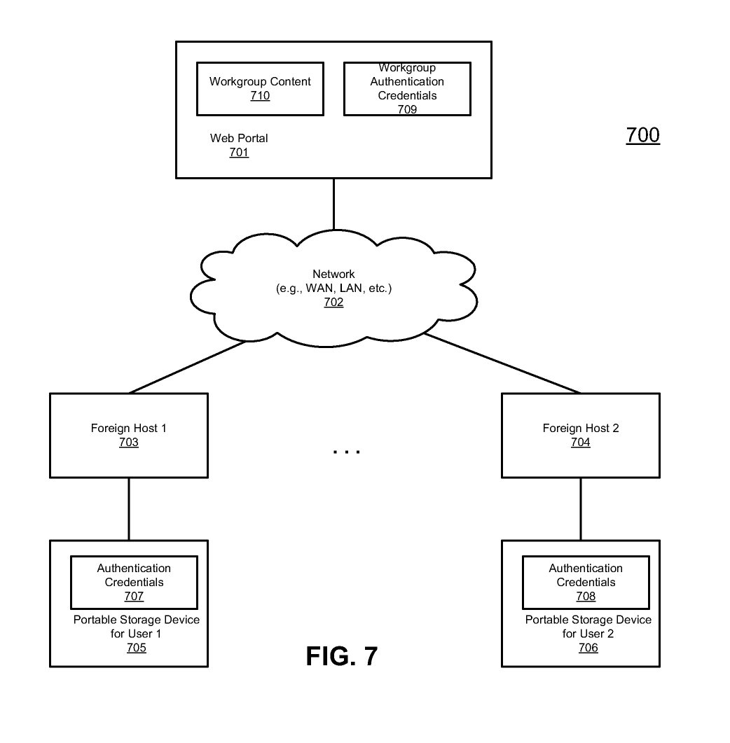

According to certain embodiments of the invention, the techniques described above may also be applied to a workgroup configuration. FIG. 7 is a block diagram illustrating an example of a workgroup configuration according to one embodiment of the invention. Referring to FIG. 7, configuration 700 includes multiple members of a workgroup each having a portable storage device having respective authentication credentials therein to access a workgroup server upon successful authentication. In this example, Web server 701 includes workgroup related content 710 and workgroup members' authentication credentials 709 such as usernames/passwords and public keys, etc. Each member of the workgroup carries a portable storage device (e.g., devices 705-706) each having its respective authentication credentials (e.g., credentials 707-708), as well as other information such as OS image and/or personal working environment as described above. When a user plugs its portable storage device into a foreign host computer (e.g., host computers 703-704), the foreign host computer may be rebooted from the portable storage device using an OS image stored in the portable storage device and configured using a personal working environment (downloaded or retrieved from the portable storage device) as described above.

In addition, the user may access server 701 and get authenticated by the server 701 in view of the corresponding authentication credentials stored in the portable storage device. Once the user is authenticated successfully, the user can access the workgroup content 710. As a result, a workgroup member may use a portable storage device as an authentication pass to access its host account in a remote facility. A user can carry its portable storage device to various foreign host computers for work, or business meeting at a remote satellite office. Alternatively, a portable storage device described herein can be used as a personalized security access to a Web server through any host computer using the authentication credentials stored therein. When a portable storage device is plugged into a host computer and the security access has been approved using the credentials stored in the portable storage device, an end user gains access to remote server (e.g., Web server or application server or content portal) to download data or content, such as media content, video streams, application software, or user data. In addition, the user can also publish certain content in the server (e.g., Web server).

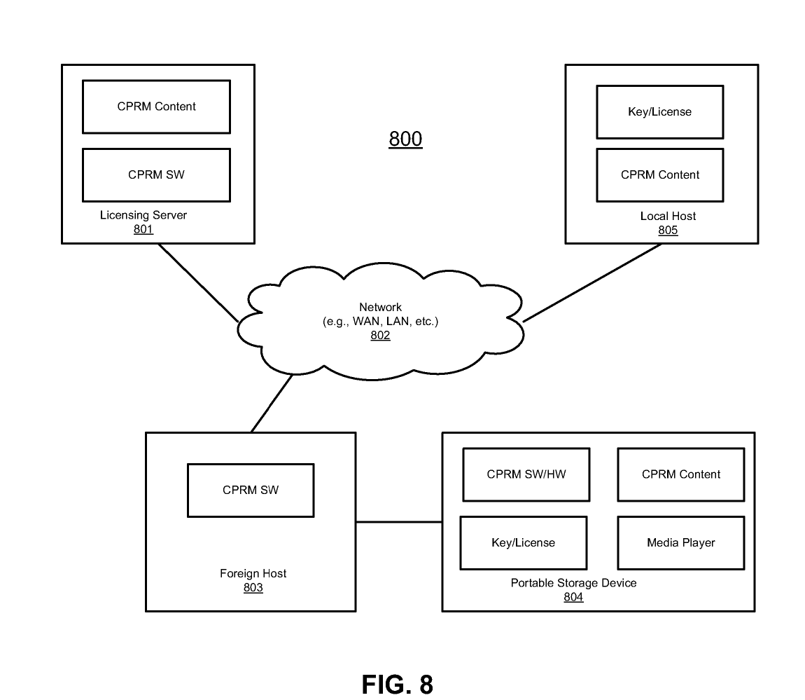

Further, the techniques described above may also be applied to handle CPRM/CPPM content using authentication credentials as well as CPRM/CPPM information stored in a portable storage device such that a user can access CPRM/CPPM content locally or remotely. FIG. 8 is a block diagram illustrating an example of system configuration which may be applied to CPRM/CPPM applications according to one embodiment of the invention. Referring to FIG. 8, a user associated with a local host 805 (e.g., home computer) replicates certain CPRM compliant data such as CPRM license/key and CPRM content (e.g., CPRM media content) into a portable storage device 804 (e.g., USB flash memory device). In addition, portable storage device 804 is equipped with CPRM software and/or hardware. When the portable storage device 804 is inserted into a foreign host computer 803, the CPRM software and/or hardware may communicate with a CPRM server 801 via the CPRM software of the foreign host computer 803 to validate certain CPRM content stored within the portable storage device 804. As a result, the user of the portable storage device 804 can access the CPRM content stored locally within the portable storage device 804 or remotely by downloading CPRM content from a remote site such as server 801 or its local host computer 805.

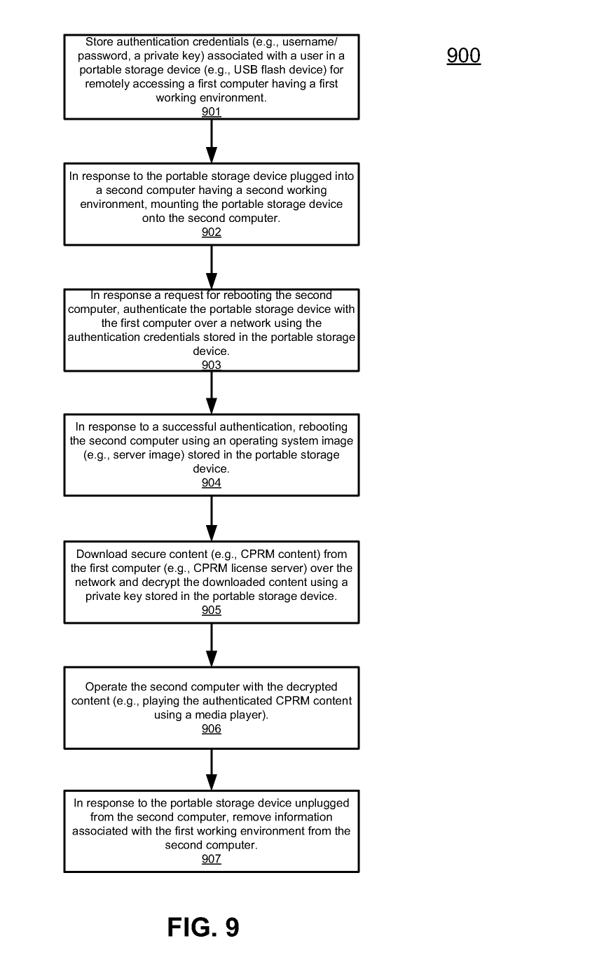

FIG. 9 is a flow diagram illustrating a process for establishing an operating environment of a host computer according to another embodiment of the invention. Note that process 900 may be performed by processing logic which may include software, hardware, or a combination of thereof. For example, process 900 may be performed by systems as shown in FIGS. 7-8. Referring to FIG. 9, at block 901, processing logic stores authentication credentials (e.g., username/password, private key, or digital certificate, etc.) associated with a user in a portable storage device (e.g., USB flash memory device) for remotely accessing a first host computer (e.g., Web server or Web portal). In response to an insertion of the portable storage device into a second host computer (e.g., foreign host computer), at block 902, the portable storage device is mounted as a storage drive. In response to a request for rebooting the second host computer, at block 903, processing logic authenticates the portable storage device with the first host computer over a network using the authentication credentials stored in the portable storage device. Upon a successful authentication, at block 904, the second host computer is rebooted using an operating system image stored in the portable storage device. At block 905, certain secure content (e.g., CPRM compliant content) may be downloaded from the first host computer over the network and decrypted using a private key stored in the portable storage device and thereafter, at block 906, the second host computer is operated with the decrypted content (e.g., using a media player to play CPRM media content such as songs and/or video streams). When the portable storage device is unplugged from the second host computer, at block 907, information or data temporarily stored in the second host computer while operating the second host computer is removed.

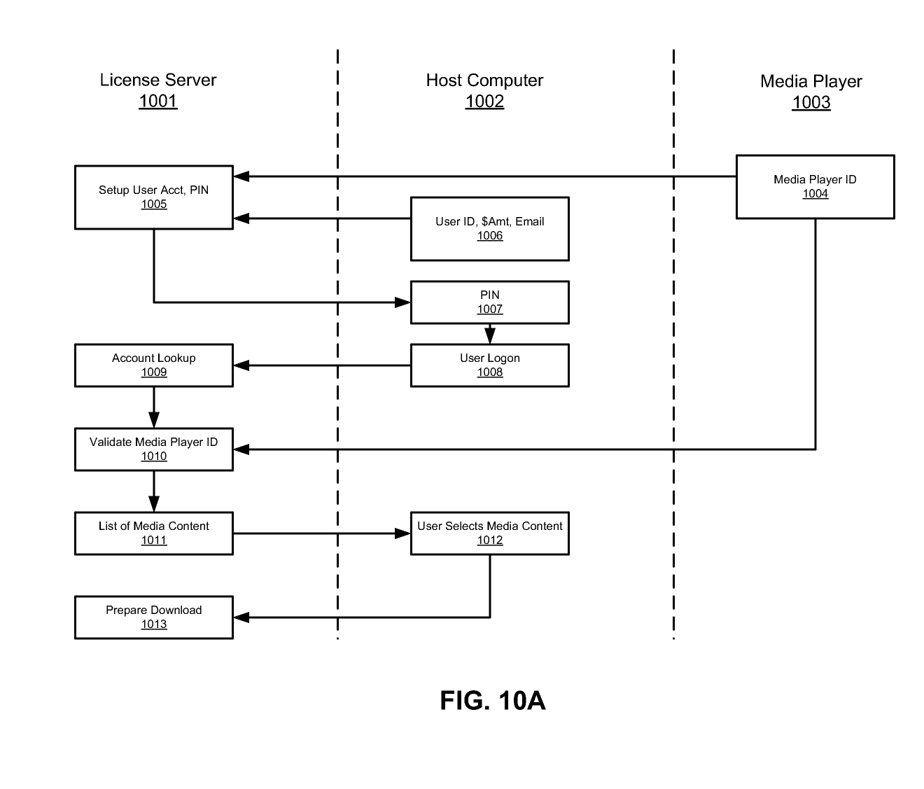

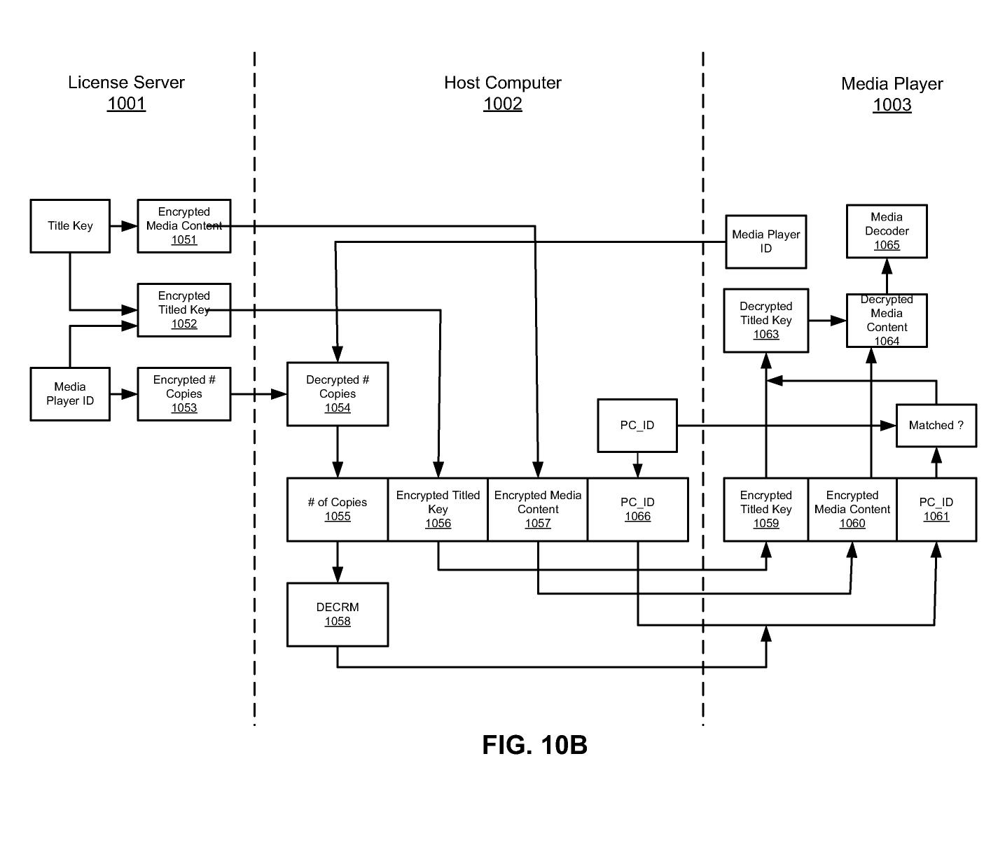

FIGS. 10A-10B show account and media player setup, media content downloading and playing for a secure digital rights management (DRM) system, according to one embodiment of the invention. For example, media player 1003 may be implemented as part of a portable storage device 804 having a built-in media player. Host computer 1002 may be implemented as part of foreign host 803. License server 1001 may be implemented as part of license server 801 of FIG. 8. In this example, the portable storage device contains a security key or a copy of valid license rights with a valid user account number or PIN (personal identification number). As described above, when the portable storage device is plugged into a host computer, a user gains access approval to remote Web server or a media content portal to view a list of media content (e.g., music, video clips, or movies, etc.) The user may purchase any of the media content from the remote server and play the purchased media content via a media player.

Referring to FIG. 10A, the manufacturer of media player 1003 pre-loads a unique media player ID 1004 into the device, or software on host PC 1002 pre-loads this unique media player ID 1004 into media player 1003. A user connects media player 1003 to host PC 1002, for example, through a USB interface, and activates special application software on host PC 1002 that reads unique media player ID 1004 from media player 1003. The user connects to license server 1001 using the software on host PC 1002 and establishes an account 1005 by sending unique media player ID 1004 to license server 1001. A user ID, account password, email address, and payment information may be provided by the user. Personal identifier number (PIN) 1007 or other acknowledgement number is generated by license server 1001 and emailed or otherwise sent to host PC 1002. PIN 1007 could also be a user-generated password or a validation code.

The user logs on to license server 1001 when desiring to download media content. Logon 1008 is responded to by license server 1001 by account lookup 1009 to find the user's account, and device ID validation 1010 that reads unique media player ID 1004 from media player 1003 and compares it to the unique media player ID stored in the user account information on license server 1001. The user is prevented from copying songs to a different device, unless that device is also registers and its unique media player ID 1004 received. Thus copying songs to many different media player devices is inhibited. The media content available for downloading is listed to the user 1011, and the user selects one or more media content for downloading 1012. The selected songs are prepared for downloading 1013 by license server 1001.

Referring to FIG. 10B, the media content selected by the user is encrypted by song encryption unit 1051, which uses a title key that is generated by license server 1001. The title key is itself encrypted by key encryptor 1052, using unique media player ID as an encrypting key. Unique media player ID 1004 was obtained from media player 1003 during account setup as shown in FIG. 10A and stored in license server 1001. The number of copies allowed, or other copy rules, are encrypted by copy encryptor 1053, which also uses unique media player ID as the encrypting key. The encrypted song, title key, and copy rules are sent from license server 1001 to host PC 1002. Host PC 1002 stores encrypted song 1057 and encrypted title key 1056 and does not need to decrypt them. However, the encrypted copy rules are decrypted by rule decryptor 1054 using unique media player ID 1004 read from media player 1003 as the decryption key. The recovered number of copies is stored as copy rules 1055, and decremented by decrementor 1058 for each copy made by host PC 1002 of encrypted song 1057.

When the number of copies remaining reaches zero, copying is disabled by host PC 1002 and encrypted song 1057 cannot be copied to media player 1003. Otherwise encrypted song 1057, encrypted title key 1056, and PC ID 1066 are copied to media player 1003 and stored as encrypted song 1060, encrypted title key 1059, and PC ID 1061 in the flash memory of media player 1003. PC ID 1066 can be the unique CPU ID from the processor in host PC 1002, a hashed ID, or some other value that identifies host PC 1002. This PC ID is also pre-loaded by host PC 1002 on media player 1003 and stored on media player 1003. PC ID 1066 may also be sent to license server 1001 such as during account logon.

When PC ID 1061 does not match the pre-loaded PC ID in media player 1003, match 1062 blocks playback by preventing decryption of encrypted title key 1059. Otherwise, when PC ID's match, encrypted title key 1059 is decrypted by decryptor 1063 to obtain the title key that unlocks encrypted song 1060 using song decryptor 1064. Media decoder 1065 can then playback the media content to the user. Further detailed information regarding the techniques described above can be found in a co-pending U.S. patent application Ser. No. 11/668,316, filed Jan. 29, 2007, which as been assigned to a common assignee of this application and is herein incorporated by reference in its entirety.

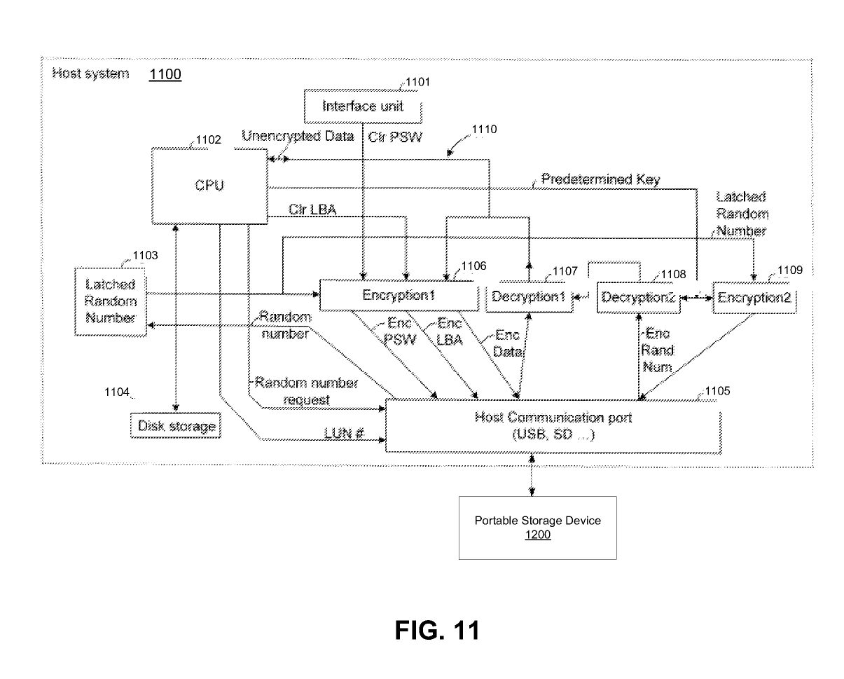

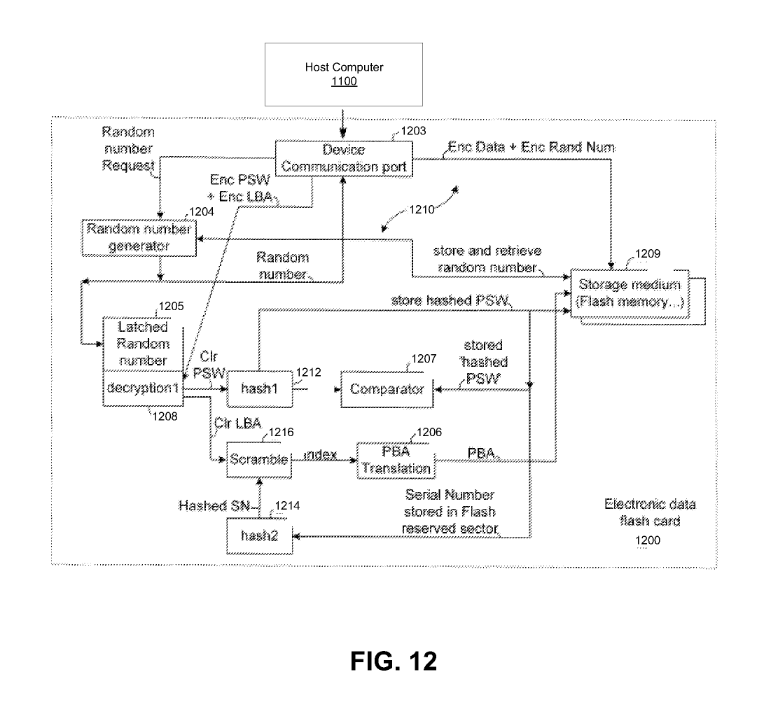

FIG. 11 is a block diagram illustrating a host computer according to one embodiment of the invention. FIG. 12 is a block diagram illustrating a portable storage device according to one embodiment of the invention. Host computer 1100 of FIG. 11 and portable storage device 1200 of FIG. 12 may be implemented as any of the host computers and portable storage devices described above. Referring to FIGS. 11 and 12, a system for providing security to an electronic data flash card includes a host system generally designated 1100 and an electronic data flash card generally designated 1200 which may be coupled to the host system 1100. The host system 100 includes a central processing unit (CPU) 1102 coupled to a bus 1110 (generally indicated by signal lines. CPU 1102 may be operable to control data flow between the host system 1100 and the electronic data flash card 1200 and to control encryption and decryption engines as further described herein. A computer interface unit 1101 is coupled to bus 1110 and provides a means for entering an unencrypted user password under CPU control. In one embodiment, computer interface unit 1101 includes a keyboard, scanner, or finger print/eye pattern reader. Disk storage 1104 is coupled to the bus 1110 and provides local storage for the CPU instructions, and stores data to be read/written to the electronic data flash card 1200.

A first latch 1103 is coupled to the bus 1110 and provides a means for temporarily storing a random number generated by a electronic data flash card random number generator 204 under control of a electronic data flash card microprocessor (not shown) as further described herein. A first encryption engine 1106 is coupled to the bus 1110 and provides encryption of an unencrypted logical block address (LBA), an unencrypted password, and unencrypted data using the latched random number. A second encryption engine 1109 is coupled to the bus 1110 and provides encryption of the latched random number using a predetermined (device specific) key to generate an encrypted random number. The predetermined key is generated by the CPU 1102 using a predetermined algorithm and a predetermined identification value that is assigned to electronic data flash card 1200 (e.g., a product identification number or device serial number, or a valid user-defined password).

In one embodiment, the predetermined key for a particular electronic data flash card is a predetermined portion of a device serial number that is transmitted from electronic data flash card 1200 to host system 1100 at power up (e.g., when electronic data flash card 1200 is plugged into a USB female socket provided on host system 1100). By generating and/or reproducing the predetermined key for each electronic data flash card 1200 in this manner, host system 1100 is not required to store the predetermined key associated with every electronic data flash card 1200 that may be coupled to host 1100, thereby minimizing the use of storage space and avoiding the need to perform an initiation process before using each electronic data flash card 1200. In addition, this approach provides host systems located at different locations a consistent way to determine the predetermined keys assigned to a large number of electronic data flash cards 1200, thereby allowing each host system to retrieve the encrypted data written by another host system.

A first decryption engine 11107 is coupled to the bus 1110 and provides decryption of encrypted data received from the electronic data flash card 1200 during a read operation using the random number provided by a second decryption engine 1108. The second decryption engine 1108 is coupled to the bus 1110 and provides decryption of the encrypted random number received from the electronic data flash card 200, also during the read operation, using the predetermined key to regenerate the random number provided to the first decryption engine 1107.

A host communication port 1105 is coupled to the bus 1110 and may include an interface such as a USB interface, a serial communication port interface, an Ethernet port interface and a wireless port interface. The host communication port 1105 is used to establish a communication link with a communication port (input/output interface circuit) 1203 of electronic data flash card 1200 over a suitable communication medium (interface bus).

In one embodiment, electronic data flash card 1200 includes microprocessor (not shown) and additional circuits that are mounted on a card body in the manner described above, and that are interconnected (coupled) by a bus 1210. In particular, random number generator 1204 is coupled to bus 1210, and provides the random number which is temporarily stored in a second latch 1205, also coupled to bus 1210. Random number generator 1204 may be a pseudo-random number generator, or use thermal noise as a source of true randomness. A storage medium 1209 is coupled to bus 1210, and in one embodiment includes one or more flash memory devices. Storage medium 1209 provides storage for the encrypted random number, the encrypted data, a hashed password as further described herein, and an electronic data flash card serial number or other identifying information that is unique to electronic data flash card 1200. Writing data to and reading data from storage medium 1209 is performed using a Physical Block Address (PBA) that is provided by a PBA translator 1206, which is coupled to bus 1210. Storage medium 1209 may further include public and secure areas.

A decryption engine 1208 is coupled to bus 1210, and provides decryption of an encrypted password and an encrypted LBA received from host system 1100. A first hash engine 1212, which is coupled to bus 1210, provides a hashed password generated from the decrypted password received from decryption engine 1208. The hashed password is stored in the storage medium 1209. A second hash engine 1214, also coupled to the bus 1210, provides, in one embodiment, a hashed serial number that is generated from the device serial number for electronic data flash card 1200 that is stored in the reserved sector of storage medium 1209. A scramble engine 1216, also coupled to the 1210, generates an index from the unencrypted LBA and the hashed serial number. PBA translator 1206 translates the index into the PBA for the address to access the storage medium 1209. A comparator 1207, also coupled to the bus 1210, compares a hashed password with a previously stored hashed password. Further detailed information regarding the host 1100 and portable storage device 1200 can be found in a co-pending U.S. patent application Ser. No. 11/685,143, filed Mar. 12, 2007, which has been assigned to a common assignee of this application and is incorporated by reference herein in its entirety.

Thus, techniques for booting a host computer from a portable storage device with customized settings with secure measure have been described herein. Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), erasable programmable ROMs (EPROMs), electrically erasable programmable ROMs (EEPROMs), magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

A machine-readable medium may include any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A computer-implemented method for establishing an operating environment of a computer, the method comprising:
in response to detecting a portable storage device inserted into a first host computer having a first operating environment provided by a first operating system (OS) installed in the first host computer, mounting the portable storage device into a file system of the first host computer;
in response to a request for rebooting the first host computer, authenticating the portable storage device using a private key stored within the portable storage device against a public key stored in a second host computer over a network;
in response to successfully authenticating the portable storage device, downloading from the second host computer over the network data representing a personal working environment associated with a user of the portable storage device;
rebooting the first host computer into a second operating environment using a second OS image stored in the portable storage device; and
configuring the second operating environment of the first host computer using the obtained settings of the personal working environment, such that the user of the portable storage device can operate the second host computer in view of the personal working environment.

2. The method of claim 1, wherein the portable storage device is a USB (universal serial bus) compatible storage device, and wherein the portable storage device is inserted into a USB interface of the first host computer.

3. The method of claim 2, further comprising:
during rebooting the first host computer, a BIOS (basic input/output system) of the first host computer invoking a control program stored in the portable storage device to take over a booting process of the first host computer,
wherein the control program of the portable storage device, when invoked from the BIOS of the first host computer, is configured to extract the second OS image from the portable storage device and to boot the first host computer using the second OS without using information from a boot sector of the first host computer.

4. The method of claim 3, further comprising:
prior to inserting the portable storage device into the first host computer, inserting the portable storage device into the second host computer;
generating the public key and the private key;
replicating the private key from the second host computer to the portable storage device;
optionally capturing personal settings associated with the second operating environment of the second host computer; and
optionally downloading the captured personal settings into the portable storage device as the personal configuration file which can be used to configure the second operating environment of the first host computer after rebooting the first host computer using the second OS image from the portable storage device.

5. The method of claim 4, wherein the second host computer is a local computer associated with the user of the portable storage device, and wherein the first host computer is a remote computer with respect to the user of the portable storage device.

6. The method of claim 5, wherein the first host computer after being configured using the personal configuration file, when operated, has an appearance of an operating environment similar to an appearance of an operating environment of the second host computer.

7. The method of claim 5, further comprising:
detecting that the portable storage device is unplugged from the first host computer; and
in response to the detection, removing one or more files associated with the personal working environment that are temporarily stored in a storage of the first host computer during operating the first host computer in the second operating environment.

8. The method of claim 7, wherein the personal configuration file comprises personal setting information selected from at least one of:
personal data and/or desktop settings;
email client and the associated data;
personal contacts including at least one of an address book and phone book;
Web browser settings including at least one of bookmarks, browser cache, and Web site login information;
anti-virus settings;
media players; and
personal communications settings.

9. The method of claim 5, wherein the second host computer is a Web server, wherein the user, upon successfully being authenticated via the private key, can access content of the Web server and/or publish content on the Web server.

10. The method of claim 9, wherein second host computer is associated with a workgroup having a plurality of members, wherein the user is a member of the workgroup, and wherein each of the plurality of members in the workgroup is able to, upon successfully authenticating the respective member with the second host computer, access the content stored in the second host computer.

11. The method of claim 9, wherein the Web server is a content protection for recordable media (CPRM) compatible server having CPRM compliant content to be downloaded, wherein the portable storage device includes CPRM authentication information which is used to authenticate and decrypt the CPRM compliant content downloaded from the Web server.

12. The method of claim 11, wherein the CPRM compliant content is media content playable via a media player stored in the portable storage device, wherein the media player is a CPRM compatible media player associated with the CPRM authentication information stored within the portable storage device.

13. A portable storage device, comprising:
a first storage area to store an operating system (OS) image;
a second storage area to store a private key; and
a bus interface logic coupled to the first storage area and the second storage area, wherein when the portable storage device is inserted into a first host computer having a first operating environment, the portable storage device is authenticated using the private key against a public key stored in a second host computer over a network,
wherein upon a successful authentication, the first host computer is rebooted; the bus interface logic causes the first host computer to boot from the OS image from the first storage area of the portable device to have a second operating environment rather than the first operating environment; and data representing a personal working environment associated with a user of the portable storage device is downloaded from the second host computer over the network, and
wherein after rebooting, the second operating environment of the first host computer is configured using the data representing the personal working environment to enable the second operating environment of the first host computer to operate in a personal settings similar to the second host computer.

14. The method of claim 13, wherein the portable storage device is a USB (universal serial bus) compatible storage device, and wherein the portable storage device is inserted into a USB interface of the first host computer.

15. A computer-implemented method for establishing an operating environment of a computer, the method comprising:
in response to detecting a portable storage device inserted into a first host computer having a first operating environment provided by a first operating system (OS) installed in the first host computer, rebooting the first host computer into a second operating environment using a second OS image stored in the portable storage device;
authenticating the portable storage device with a second host computer over a network using a private key stored in the portable storage device against a public key stored in the second host computer;
in response to a successful authentication, downloading secured content from the second host computer over the network to the first host computer;
decrypting the downloaded secured content in the first host computer, including decrypting content protection for recordable media (CPRM) compatible content using CPRM authentication information stored within the portable storage device; and
accessing the downloaded and/or decrypted content within the second operating environment including playing CPRM compliant media content using a CPRM compliant media player executed from the portable storage device.

16. The method of claim 15, wherein the portable storage device is a USB (universal serial bus) compatible storage device, and wherein the portable storage device is inserted into a USB interface of the first host computer.

17. The method of claim 16, further comprising:
mounting the portable storage device into a file system of the first host computer prior to rebooting the first host computer; and
during rebooting the first host computer, a BIOS (basic input/output system) of the first host computer invoking a control program stored in the portable storage device to take over a booting process of the first host computer,
wherein the control program of the portable storage device, when invoked from the BIOS of the first host computer, is configured to extract the second OS image from the portable storage device and to boot the first host computer using the second OS without using information from a boot sector of the first host computer.

18. The method of claim 17, further comprising:
prior to inserting the portable storage device into the first host computer, inserting the portable storage device into the second host computer;
generating the public key and the private key; and
replicating the private key from the second host computer to the portable storage device.

19. The method of claim 18, wherein the second host computer is a Web server which is a content protection for recordable media (CPRM) compatible server having CPRM compliant content to be downloaded, wherein the portable storage device includes CPRM authentication information which is used to authenticate and decrypt the CPRM compliant content downloaded from the Web server.

20. The method of claim 19, wherein the CPRM compliant content is media content playable via a media player stored in the portable storage device, wherein the media player is a CPRM compatible media player associated with the CPRM authentication information stored within the portable storage device.
